(19) United States
(12) Patent Application Publication
(10) Pub. No.: US 2008/0250647 A1
(43) Pub. Date: Oct. 16, 2008

(54) MULTI-USE SHAVING IMPLEMENT

(75) Inventors: Stephan Fischer, Gevelsberg (DE); Jochen Thoene, Wuppertal (DE); Matthias Niggemann, Wuppertal (DE); Kelvin Stewart, Milford, CT (US)

Correspondence Address: Michaud-Duffy Group LLP, 306 Industrial Park Road, Suite 206, Middletown, CT, 06457, US

(73) Assignee: EVEREADY BATTERY COMPANY, INC., St. Louis, MO (US)

(21) Appl. No.: 12/102,166

(22) Filed: Apr. 14, 2008

Related U.S. Application Data
(60) Provisional application No. 60/923,433, filed on Apr. 13, 2007.

(51) Int. Cl. B26B 21/00

(52) U.S. Cl. 30/50

(57) ABSTRACT

According to one aspect of the present invention, a razor cartridge includes an outer shell, and a support structure. The outer shell defines a primary blade opening and a trimming blade opening. The support assembly is located at least partially inside the outer shell and includes at least one primary blade slot and a trim blade slot. A primary blade is located within each of the primary blade slots in the support assembly such that a cutting edge on the primary blade extends through the primary blade opening in the outer shell. A trim blade is located within the trim blade slot in the support structure such that a cutting edge on the trim blade extends through the trim blade opening in the outer shell.

### CROSS-REFERENCE TO RELATED APPLICATION

This application claims the benefits of U.S. Provisional Patent Application Ser. No. 60/923,433, filed on Apr. 13, 2007, the contents of which are incorporated by reference herein in their entirety.

### TECHNICAL FIELD

The present invention is generally directed to shaving implements in general, and to shaving implements employing razor cartridges having at least one (1) primary blade and at least one (1) trim blade.

### BACKGROUND

Most prior art shaving implements, also commonly known as wet shave razors, include a razor cartridge and a handle. The razor cartridge typically includes at least one primary blade that is positioned aft of a primary guard bar and forward of a primary cap. During use, the razor cartridge is mounted on a handle such that it can pivot relative to the handle between a resting position and a rotated position.

The prior art razors described above are quite useful for shaving a surface short hair, or stubble, from a surface. However, they are not as useful for maintaining and shaping features such as side bums, mustaches and goatees. This difficulty is due, in part, to the fact that the razor cartridge pivots relative to the cartridge. While the pivoting action is beneficial for keeping the primary blade(s) in contact with the skin during a longer shaving, it is not as beneficial during shorter strokes made when trimming/shaping.

U.S. Pat. No. 6,276,061 to Rozenkranc discloses a razor cartridge having both at least one primary blade and at least one trim blade. In the '061 patent, the inventor also discloses how a razor cartridge and handle combination that utilizes a unidirectional pivot can be advantageously used. When shaving with the primary blade(s), the cartridge is able to pivot relative to the handle. When shaving with the trim blade(s), the handle is rotated 180 degrees such that the razor cartridge is forced against a stop, preventing the razor from pivoting relative to the handle. Therefore, the razor is able to pivot when it is beneficial, but prevented from pivoting when it is not desired.

The '061 patent does not disclose a method of manufacturing a razor cartridge having both primary blade(s) and trim blade(s). Other prior art devices have suggested manufacturing a separate trim assembly and attaching it to a separate assembly containing the primary blade(s). However, such a process has inherent difficulties due, at least in part, to the fact that it requires several additional parts and manufacturing steps.

Based on the foregoing, it is the general object of the present invention to provide a shaving device that overcomes the problems and drawbacks associated with the prior art.

### SUMMARY OF THE INVENTION

According to one aspect of the present invention, a razor cartridge includes an outer shell, and a support structure. The outer shell defines a primary blade opening and a trimming blade opening. The support assembly is located at least partially inside the outer shell and includes at least one primary blade slot and a trim blade slot. A primary blade is located within each of the primary blade slots in the support assembly such that a cutting edge on the primary blade extends through the primary blade opening in the outer shell. A trim blade is located within the trim blade slot in the support structure such that a cutting edge on the trim blade extends through the trim blade opening in the outer shell.

According to another aspect of the invention, a wire is wrapped around to the support assembly. In some embodiments, the wire extends over the cutting edge(s) of the primary blade(s) in order to protect the user's skin during shaving. In other embodiments, the wire extends over the primary blade(s) and the trim blade in order to protect the user's skin during shaving as well as during trimming/shaping.

According to a further aspect of the present invention, the razor cartridge includes handle connecting members which pivotally mount the razor cartridge on a handle. In these embodiments, the handle is able to pivot when shaving with the primary blades, but prevented from pivoting during trimming/shaping.

The advantages of the present invention will be apparent to one of skill in the art in light of at least the above Summary, the included Drawings, and the Detailed Description of the Invention.

### BRIEF DESCRIPTION OF THE DRAWINGS

FIG. 1 is an isometric front view of one embodiment of the shaving device of the present invention displaying the one or more primary blades;

FIG. 2 is an isometric rear view of shaving device shown in FIG. 1 displaying the one or more trimming blades;

FIG. 3 is a isometric view of one embodiment of the present invention depicting the support assembly of one embodiment of the present invention;

FIG. 4 is a sectional view of the support assembly shown in FIG. 3 along line 4-4;

FIG. 5 is a partial side view of the support assembly shown in FIG. 7 showing the one or more primary blade slots and the one or more trimming slots in the support assembly;

FIG. 6 is an sectional view of the support assembly shown in FIG. 3 along line 6-6, wherein primary blades are located in the primary blade slots and a trimming blade is located in the trimming blade slot in the support assembly;

FIG. 7 is a bottom isometric view of the support assembly of FIG. 3, wherein primary blades are located in the primary blade slots and a trimming blade is located in the trimming blade slot in the support assembly;

FIG. 8 is a side view of one embodiments of the razor cartridge of the present invention connected to a handle;

FIG. 9 is a side view of the razor cartridge and handle of FIG. 8, wherein the razor cartridge is rotated relative to the handle; and

FIG. 10 is a side view of the razor cartridge and handle of FIG. 8, wherein the trim blade is in use.

### DETAILED DESCRIPTION OF THE INVENTION

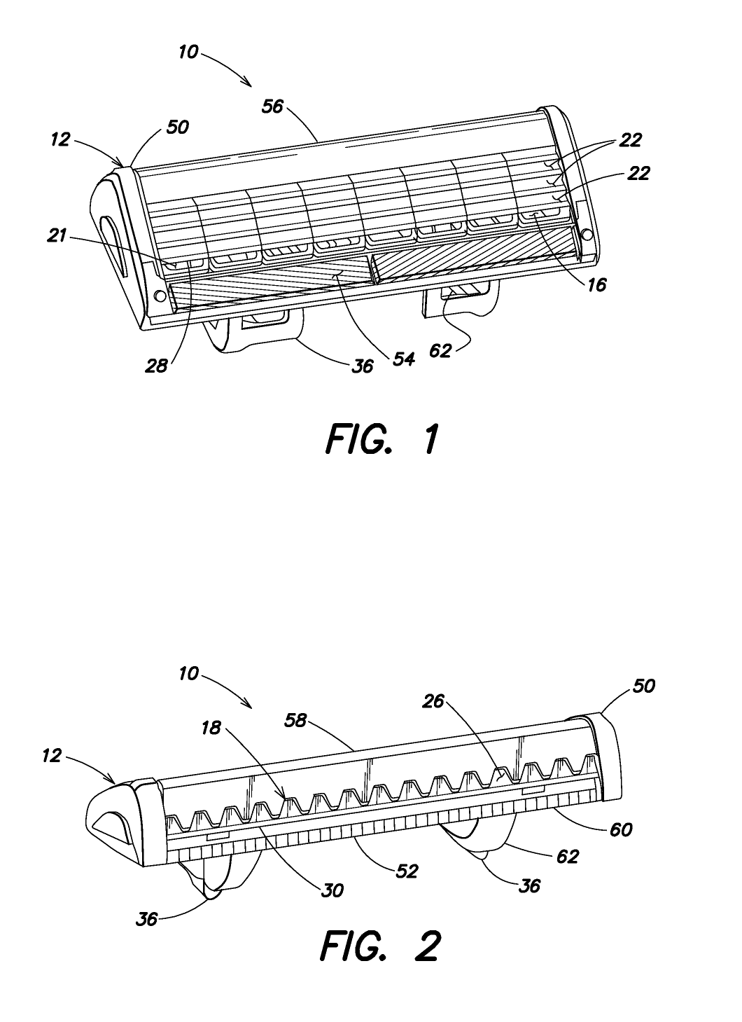

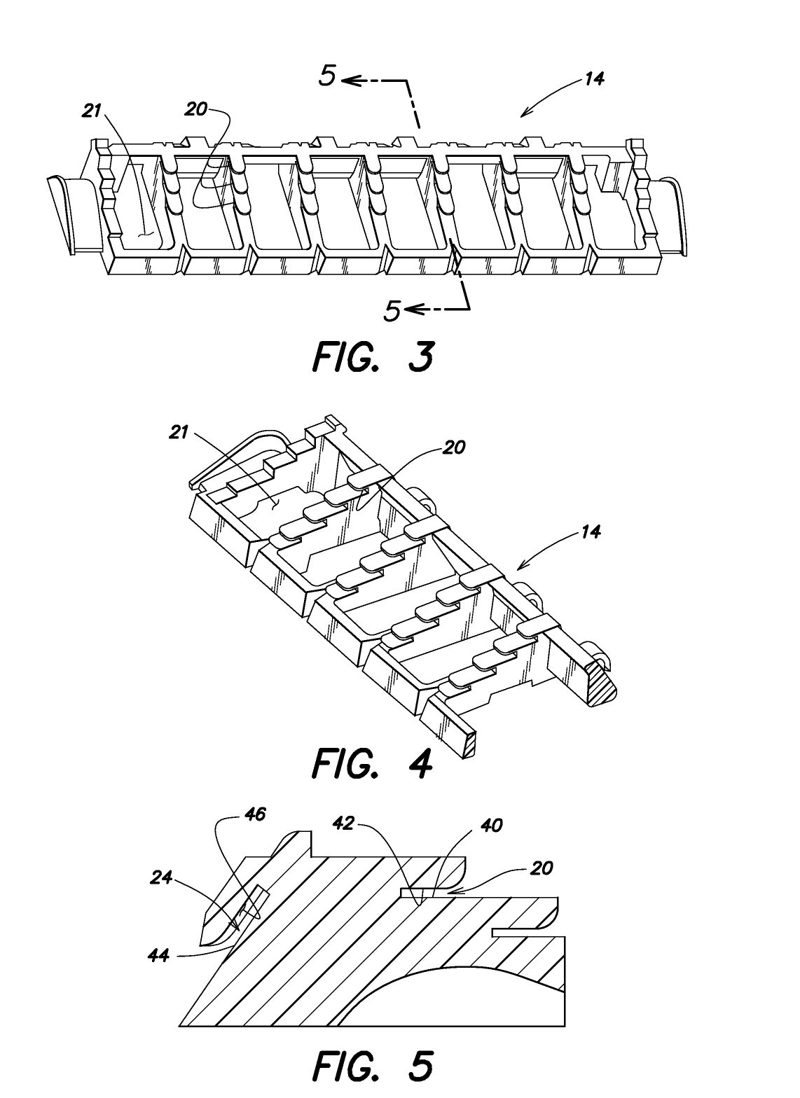

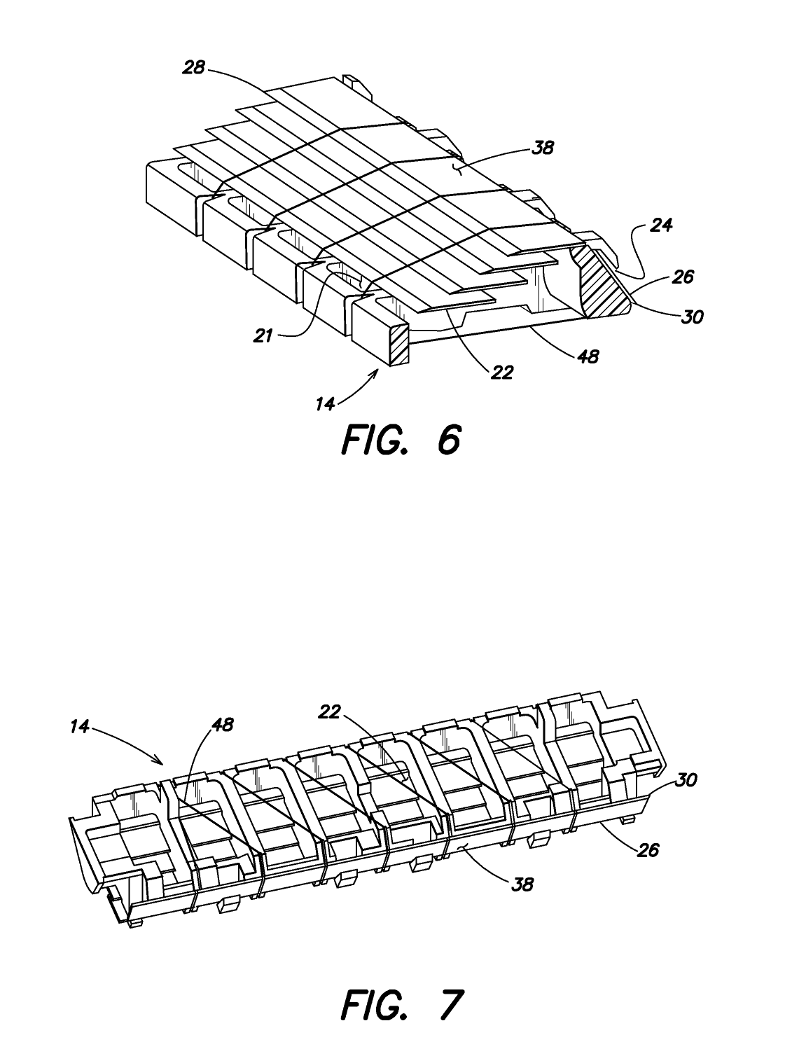

Referring to FIGS. 1-7, a razor cartridge 10 includes an outer shell 12, and a support structure 14. The outer shell 12 defines a primary blade opening 16 (FIG. 1) and a trim blade opening 18 (FIG. 2). The support structure 14 (FIGS. 3-6) is located at least partially inside the outer shell 12 and defines a at least one primary blade slot 20 for receiving a primary blade 22 and a trim blade slot 24 for receiving a trim blade 26. A primary blade 22 (FIG. 6) is located within each of the primary blade slots 20 in the support structure 14 such that a cutting edge 28 on the primary blade extends through the primary blade opening in the outer shell. In the embodiment shown, there are four (4) primary blades 22. A trim blade (FIG. 7) is located within each of the trim blade slots 24 in the support structure 14 such that a cutting edge 30 on the trim blade 26 extends through the trim blade opening 18 in the outer shell 12. In the embodiment shown, there is one (1) trim blade 26; however the razor cartridge 10 can have more than one (1) trim blade 26 without departing from the scope of the present invention.

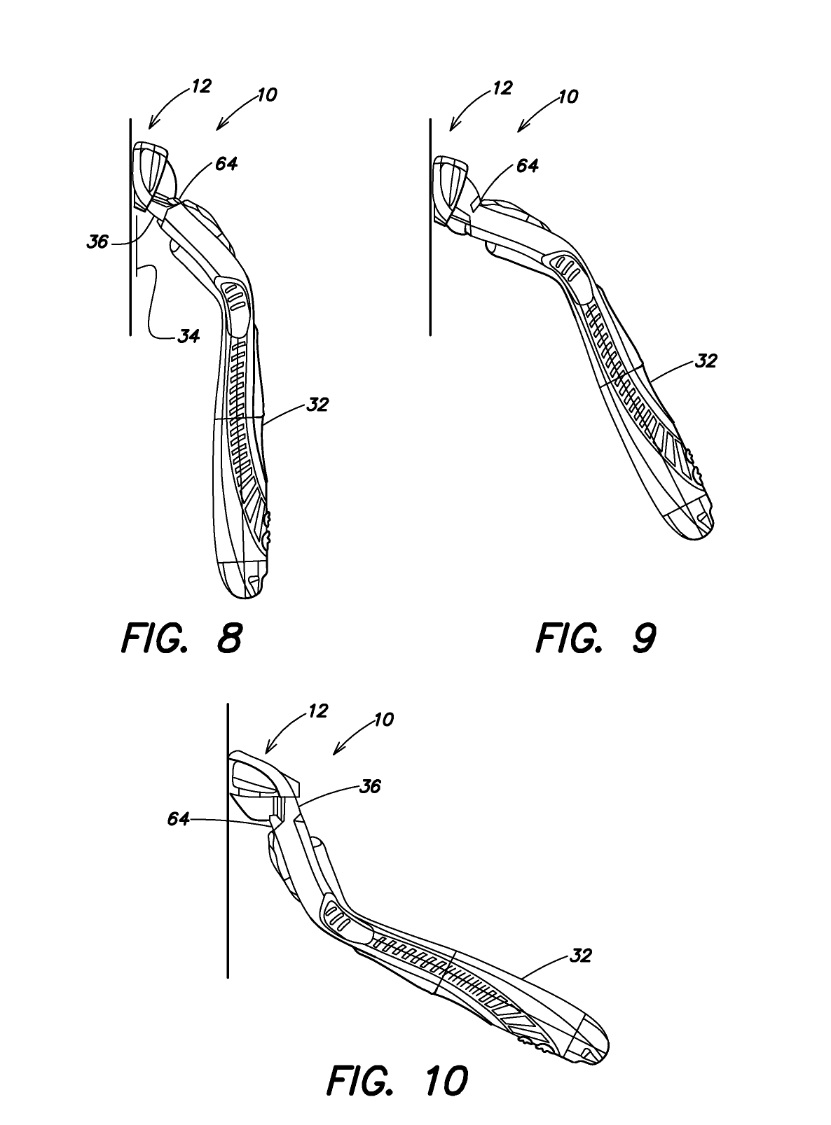

Referring now to FIGS. 8-10, the razor cartridge 10 of the present invention can be connected to a handle 32 for ease of use. Typically, the razor cartridge is pivotally mounted to the handle 32 such that it can pivot between a rest position 34 (FIG. 8) and a rotated position (FIG. 9). Stops 36, which are known in the art, can be used to define the rest position 34. The handle 32 can be removable from the razor cartridge 10 such that, once the blades 22 have become dull, a new razor cartridge 10 can be attached to the reusable handle 32 or, alternatively, the handle 32 can be attached to the cartridge 10 in manner such that the two are not intended to be removed from one another (i.e., a disposable razor).

Blades 22, 26 are well known in the art. The present invention includes at least one trim blade 26, and at least one primary blade 22. As shown in FIGS. 1 and 6, the present invention can have two (2) or more primary blades 22 without departing from the scope of the present invention. Typically, blades (both primary and trim) 22, 26 include a blade body 38 and a sharpened cutting edge 28, 30. In most cases, the sharpened cutting edge 28, 30 has various coatings applied thereon to improve its ability to shave hair.

The support structure 14, as shown for example in FIGS. 3-7, includes at least one primary blade slot 20, and a trim blade slot 24. Preferably, the primary blade slot(s) 20 and trim blade slot 24 are not continuous across the width of the cartridge 10. Rather, each slot 20, 24 is typically comprised of a series of spaced apart portions (See e.g. FIGS. 3-4) that, together, provide support along the single blade 22, 26 to which the slot 20, 24 is providing support.

Typically, the primary slots 20 include a lower side 40 and an upper portion 42. When a primary blade 22 is placed within the primary slot 20, the lower side 40 of the primary slot 20 supports one side of the primary blade body 38, and the upper portion 42 of the primary slot 20 is in contact with opposite side of the primary blade body 38. The primary blade body 38 can be held in place in the primary slot 20 by a snap fit, press fit, or, in some instances, the primary blade body 38 can be glued or adhered to the primary slot 20. In fact, any manner known to one of skill in the art in which the primary blade 22 can be properly held in place within the primary blade slot 20 is acceptable.

In some embodiments, it is preferable that the lower side 40 of the forwardmost primary slot 21 extend to a position forward of the cutting edge 28 of the primary blade 22 positioned therein. In doing so, the lower side 40 of the forwardmost primary blade slot 21 sets the angle at which the skin approaches the primary blade 22.

The trim blade slot 24 also includes a lower side 44 and an upper portion 46. When the trim blade 26 is placed within the trim slot 24, the lower side 44 of the trim blade slot 24 supports one side of the trim blade body 38, and the upper portion of the trim blade slot 24 is in contact with opposite side of the trim blade body 38. The trim blade body 38 can be held in place in the trim slot 24 by a snap fit, press fit, or, in some instances, the trim blade body can be glued or adhered to the trim slot 24. In fact, any manner known to one of skill in the art in which the trim blade 24 can be properly held in place within the trim slot is acceptable.

Referring to FIG. 5, the primary slots 20 are generally positioned so that, in embodiments having more than one primary blade 22, the primary blades 22 are generally parallel to one another. The trim slot 24 is generally positioned relative to the primary slot(s) 20 such that the trim blade 26 is positioned at an angle between 60 degrees and 160 degrees. Preferably, the angle between the trim blade and the primary blades is greater than 120 degrees.

Referring now to FIGS. 1, 6, and 7, in some instances, a wire 48 is placed around the trim and/or primary blade(s) 22, 24. Preferably, the wire 48 is made of, or is coated with, a low friction material. Wire 48 are generally known in the art to reduce friction that occurs during shaving, as well as to prevent nicks and cuts. In some embodiments, the wire 48 is wound around the blades 22, 26 and the support structure 14.

The blades 22, 26 and support structure 14 are at least partially enclosed within an outer shell 12. The outer shell 12 includes two pieces, a top portion 50 and a bottom portion 52. The top portion 50 can include a primary blade opening 16, a primary guard 54 and a primary cap 56. When the support structure 14 and blades 22, 26 are placed in the top portion 50 of the outer shell 12, the primary blades 22 are positioned in the primary blade opening 16 where they are operable to shave a hirsute surface. The primary guard 54 can be made from a plastic, metal, or elastomeric material and can, in some instances, include bumps, fins, or other protrusions. The primary guard 54 generally stretches the skin prior to encountering the primary blades 22. The primary cap 56 is typically made from, or applied with a low friction material. In some instances, the primary cap 56 can lubricate the skin once it has passed over the primary blade(s) 22.

The top portion 50 also defines a trim blade opening and includes a blade cap 58. In some embodiments, the top portion 50 also includes a blade guard 60. Alternatively, the blade guard 60 can be at least partially formed by the bottom portion 52 of the outer shell 12, as well. When the support structure 14 and blades 22, 26 are placed in the top portion of the outer shell 12, the trim blade 26 is positioned in the trim blade opening 18 where it is operable to trim a hirsute surface. The trim blade guard is located in front of the trim blade 26 and can be made from a plastic, metal, or elastomeric material. The trim blade guard 60 can, in some instances, include bumps, fins, or other protrusions (See e.g. FIG. 2) which act to stretch the skin prior to the skin passing over the trim blade 26. The trim blade cap 58 is typically comprised of a low friction material. In some instances, the trim blade cap 58 can lubricate the skin once the skin has passed over the trim blade 26. The trim blade cap 58 can have a comb-like shape. (See e.g. FIG. 2).

The bottom portion 52 at least partially encloses the support structure 14 within the outer shell. The bottom portion 52 is secured to the top portion 50 via a snap fit, press fit, or, in some cases, the two can be glued or adhered together. In many instances, the bottom portion 52 includes connecting structures 60 for pivotally connecting the razor cartridge 10 to the handle 32. As shown in FIGS. 1 & 2, the embodiment depicts a shell bearing 62 style connection that is known in the art. Although shell bearings 62 are shown in FIGS. 1 & 2, any suitable style of connectors 60 can be used to connect the razor cartridge with the handle 32 without departing from the scope of the present invention. Typically, a unidirectional style pivoting structure 60 also utilizes a resilient member (e.g., a spring) 64, a shown in FIG. 8-10, to urge the razor toward a rest position 34 is preferred.

Referring now to FIGS. 8-10, during shaving, as the razor cartridge passes over bumps and/or curves, the forces encountered during shaving cause the razor cartridge to pivot away from the rest position 34. Once the shaving forces have ceased, the resilient member 64 returns the razor cartridge 10 to the rest position 34. The opposite is true during use of the trim blade 26. Because the forces that occur during trimming urge the razor cartridge 10 toward the rest position 34, the razor cartridge 10 is prevented from pivoting during trimming.

Modification and variations may be made to the disclosed embodiments without departing from the subject and spirit of the invention as defined by the following claims.

What is claimed is:

1. A razor cartridge, comprising:
a support assembly having at least one primary blade slot and at least one trim blade slot;
a primary blade positioned in each of the at least one primary blade slots;
a trim blade positioned in the trim blade slot such that the trim blade is at an angle between 60 and 180 degrees relative to the primary blade;
an outer shell having a top portion and a bottom portion, the top portion defining a primary opening and a trim opening;
wherein when the support assembly, primary blade(s), and trim blade are positioned within the top portion, the primary blade(s) are positioned in the primary opening and the trim blade is positioned in the trim opening; and
wherein the bottom portion is secured to the top portion, enclosing the support assembly, primary blade(s) and trim blade at least partially therein.

2. The razor cartridge of claim 1, wherein at least one of the primary blades and trim blades are wrapped by a wire.

3. The razor cartridge of claim 1, wherein the top portion includes a primary guard.

4. The razor cartridge of claim 1, wherein the top portion includes a primary cap.

5. The razor cartridge of claim 1, wherein the top portion includes a trim guard.

6. The razor cartridge of claim 1, wherein the top portion includes a trim cap.

7. The razor cartridge of claim 1, wherein the bottom portion includes a trim guard.

8. The razor cartridge of claim 1, wherein the support structure has at least two primary blade slots and, wherein the forwardmost primary blade slot includes a lower side that extends to a position forward of a cutting edge of the primary blade positioned in the forwardmost primary blade slot.

9. A razor cartridge, comprising:
a support assembly having at least at least two primary blade slots;
a primary blade having a cutting edge is positioned in each of the at least one primary blade slots;
an outer shell having a top portion and a bottom portion, the top portion defining a primary opening;
wherein when the support assembly, primary blade(s), and trim blade are positioned within the top portion, the primary blade(s) are positioned in the primary opening;
wherein the bottom portion is secured to the top portion, enclosing the support assembly, primary blade(s) and trim blade at least partially therein;
wherein the support assembly is movable within the outer shell during shaving; and
wherein the support assembly extends to a position forward of the cutting edge of the primary blade positioned in the forwardmost blade slot.

10. The razor assembly of claim 9, wherein a lower side of the forwardmost primary blade slot sets the angle at which skin being shaved during normal shaving approaches the cutting edge of the forwardmost primary blade.
